(19) United States
(12) Patent Application Publication
(10) Pub. No.: US 2014/0002601 A1
(43) Pub. Date: Jan. 2, 2014

(54) STEREOSCOPIC IMAGE OUTPUT DEVICE AND STEREOSCOPIC IMAGE OUTPUT METHOD

(71) Applicant: Shotaro Takano, Hyogo (JP)

(72) Inventor: Shotaro Takano, Hyogo (JP)

(73) Assignee: PANASONIC CORPORATION, Osaka (JP)

(21) Appl. No.: 14/002,973

(22) PCT Filed: Mar. 7, 2012
(86) PCT No.: PCT/JP2012/001557

§ 371 Date: Sep. 3, 2013

(30) Foreign Application Priority Data
Mar. 10, 2011 (JP) 2011-052683

(51) Int. Cl. H04N 13/00

(52) U.S. Cl. CPC H04N 13/0051
USPC 348/43

(57) ABSTRACT

Provided is a stereoscopic image output device including: an image acquisition unit which acquires a left-eye image and a right-eye image which form a stereoscopic image; a display unit which alternately displays the left-eye image and the right-eye image acquired by the image acquisition unit; a safety determination unit which determines whether the stereoscopic image is a safe image by comparing a normal distribution curve of disparities between corresponding points in the left-eye image and the right-eye image and a safe range of disparity indicating a range of disparity in which the stereoscopic image is recognized as a safe image for a viewer; and a notification unit which notifies the viewer that the stereoscopic image is not a safe image when the safety determination unit determines that the stereoscopic image is not a safe image.

### TECHNICAL FIELD

The present invention relates to stereoscopic image output devices and stereoscopic image output methods, and, more particularly, to a stereoscopic image output device and a stereoscopic image output method which consider safety for a viewer.

### BACKGROUND ART

Conventionally, image display devices are known which select, from among a plurality of captured images, a pair of images for use as a left-eye image and a right-eye image for stereoscopic viewing, and display a stereoscopic image using the pair of images (for example, see PTL 1).

Such image display devices present to a user a plurality of pairs of images the similarity of which is within a predetermined threshold, and display a pair of images selected by the user from among the presented pairs of images as a left-eye image and a right-eye image. This allows the user to view the selected images as a stereoscopic image.

### CITATION LIST

### Patent Literature

[PTL 1] Japanese Unexamined Patent Application Publication No. 2004-104330

### SUMMARY OF INVENTION

### Technical Problem

The stereoscopic image created by the image display devices described above, however, may include a left-eye image and a right-eye image the disparity therebetween is significantly large. In other words, when the user views such images, the user's health may be adversely affected.

Thus, the present invention is made in light of the above problems and has an object to provide a stereoscopic image output device and a stereoscopic image output method which can properly determine the safety of a stereoscopic image and notify the safety to the user when displaying a stereoscopic image.

### Solution to Problem

To solve the above problem, a stereoscopic image output device according to one aspect of the present invention is a stereoscopic image output device including: an image acquisition unit configured to acquire a left-eye image and a right-eye image which form a stereoscopic image; an output unit configured to output the left-eye image and the right-eye image acquired by the image acquisition unit; a safety determination unit configured to determine whether the stereoscopic image is a safe image by comparing a normal distribution curve obtained from disparities between corresponding points in the left-eye image and the right-eye image and a safe range of disparity indicating a range of disparity in which the stereoscopic image is recognized as a safe image for a viewer; and a notification unit configured to notify the viewer that the stereoscopic image is not a safe image when the safety determination unit determines that the stereoscopic image is not a safe image.

According to the above configuration, a safe stereoscopic image can be outputted by correctly determining and notifying a user of the safety of the stereoscopic image.

Moreover, the safety determination unit may extract, from the left-eye image and the right-eye image, a plurality of feature points for specifying a shape of a subject included in the stereoscopic image, calculate disparities between the feature points corresponding to each other in the left-eye image and the right-eye image, and approximate a frequency distribution of the calculated disparities, to calculate the normal distribution curve.

Moreover, the safety determination unit may determine that the stereoscopic image is a safe image when a percentage of an area of a region included in the safe range of disparity over an area of a region enclosed by the normal distribution curve is greater than or equal to a predetermined threshold.

Moreover, the output unit may be a display unit configured to alternately display the left-eye image and the right-eye image, and when the safety determination unit determines that the stereoscopic image is not a safe image, the notification unit may show, on the display unit, that the stereoscopic image is not a safe image.

Moreover, the display unit may altern ately display the left-eye image and the right-eye image only when the safety determination unit determines that the stereoscopic image is a safe image.

Moreover, the stereoscopic image output device may further include a stereoscopic image generation unit configured to acquire a first image and a second image obtained by taking images of a subject from different positions, and rotate or move the second image so that disparities between corresponding points in the first image and the second image are minimized in a vertical direction of the first image and the second image, to generate a third image, wherein the image acquisition unit may acquire one of the first image and the third image as the left-eye image, and the other as the right-eye image.

Moreover, the image acquisition unit may acquire a plurality of the left-eye images and a plurality of the right-eye images which form a stereoscopic video in a playback order of the stereoscopic video.

Moreover, the safe range of disparity may be a range of disparity determined by a biomedical safety guideline.

Moreover, a stereoscopic image output method according to one aspect of the present invention is a stereoscopic image output method including: (a) acquiring a left-eye image and a right-eye image which form a stereoscopic image; (b) alternately outputting the left-eye image and the right-eye image acquired in step (a); (c) determining whether the stereoscopic image is a safe image by comparing a normal distribution curve of disparities between corresponding points in the left-eye image and the right-eye image and a safe range of disparity indicating a range of disparity in which the stereoscopic image is recognized as a safe image for the viewer; and (d) notifying the viewer that the stereoscopic image is not a safe image when it is determined that the stereoscopic image is not a safe image.

### Advantageous Effects of Invention

According to a stereoscopic image output device and the stereoscopic image output method of the present invention, the display of a safe stereoscopic image is possible by correctly determining, using a normal distribution of disparities, the safety of the stereoscopic image and notifying the determination result to a user.

### BRIEF DESCRIPTION OF DRAWINGS

FIG. 1 is a block diagram showing the configuration of a stereoscopic image output device according to an embodiment of the present invention.

FIG. 2 is an example display of a message indicating that a stereoscopic image is not a safe image.

FIG. 3 is a flowchart illustrating operation of the stereoscopic image output device according to the embodiment of the present invention.

FIG. 4 is a diagram illustrating a method for generating a stereoscopic image by a stereoscopic image generation unit.

FIG. 5 is a flowchart illustrating generation of a stereoscopic image by the stereoscopic image generation unit.

FIG. 6 is a flowchart illustrating a safety determination process of a safety determination unit.

FIG. 7 is a diagram illustrating signs of disparity.

FIG. 8 is a diagram showing an example where incorrect feature points are associated with each other.

FIG. 9 is a diagram showing another example where incorrect feature points are associated with each other.

FIG. 10 is a diagram showing an example distribution of disparities which is determined to be safe by the safety determination unit.

FIG. 11 is a diagram showing an example distribution of disparities which is determined to be unsafe by the safety determination unit.

FIG. 12 is a diagram showing an application of the stereoscopic image output device according to the embodiment of the present invention.

FIG. 13 is a diagram showing another application of the stereoscopic image output device according to the embodiment of the present invention.

### DESCRIPTION OF EMBODIMENTS

Hereinafter, embodiments of the present invention will be described with accompanying drawings.

It should be noted that the embodiments described below are each merely a preferred illustration of the present invention. Values, shapes, materials, components, disposition or a form of connection between the components, steps, and the order of the steps are merely illustrative, and are not intended to limit the present invention. Moreover, among components of the below non-limiting embodiments, components not set forth in the independent claims indicating the top level concept of the present disclosure will be described as optional components for preferable embodiments.

First, the configuration of a stereoscopic image output device will be described.

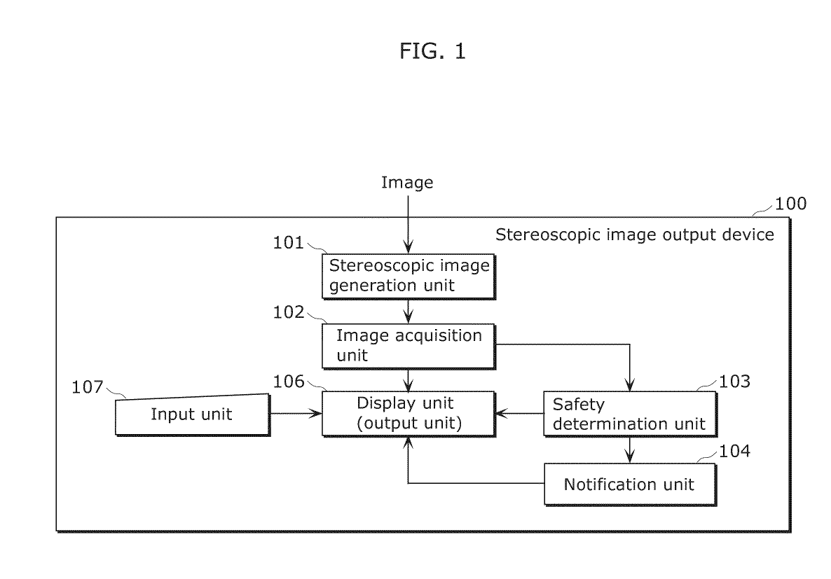

FIG. 1 is a block diagram showing the configuration of a stereoscopic image output device according to an embodiment of the present invention.

As shown in FIG. 1, a stereoscopic image output device 100 includes a stereoscopic image generation unit 101, an image acquisition unit 102, a safety determination unit 103, a notification unit 104, a display unit 106 (an output unit), and an input unit 107.

It should be noted that the stereoscopic image output device 100 may include, while not shown, components such as a reception unit which receives broadcast signals, a communication unit which establishes a connection to a network, a physical medium attachment for connection to a recording medium, and a sound output unit for outputting sound signals. These components, however, are not directly related to the present invention. Thus, the description will be omitted in the present embodiment.

The stereoscopic image generation unit 101 generates a left-eye image and a right-eye image which form a stereoscopic image, and outputs the left-eye image and the right-eye image to the image acquisition unit 102. The left-eye image is an image which forms a stereoscopic image and to be shown to the left eye of a viewer. The right-eye image is an image which forms a stereoscopic image and to be shown to the right eye of the viewer. The stereoscopic image generation unit 101, for example, takes an image by using an imaging device (not shown), and generates a stereoscopic image (the left-eye image and the right-eye image). In other words, the stereoscopic image output device 100 is applicable to digital still cameras (DSC) and the like.

It should be noted that the stereoscopic image generation unit 101 may acquire two-dimensional images from broadcast waves or a recording medium, and generate a stereoscopic image from the acquired two-dimensional images.

The image acquisition unit 102 acquires a left-eye image and a right-eye image which form a stereoscopic image which allows a user to stereoscopically view a subject, and outputs the left-eye image and the right-eye image to the safety determination unit 103 and the display unit 106 (output unit).

Specifically, the image acquisition unit 102 acquires the left-eye image and the right-eye image generated by the stereoscopic image generation unit 101.

It should be noted that the stereoscopic image generation unit 101 may be omitted and the image acquisition unit 102 may directly acquire the left-eye image and the right-eye image.

In this case, the image acquisition unit 102 may acquire images through broadcast waves or a communication network. Specific examples of the broadcast waves are not particularly limited. For example, the image acquisition unit 102 acquires images from analog broadcasting, terrestrial digital broadcasting, broadcast satellite (BS) broadcasting, and communication satellite (CS).

In other words, the stereoscopic image output device 100 is applicable to television sets and the like.

Also, the image acquisition unit 102 may retrieve images from a recording medium. Specific examples of the recording medium are not particularly limited. For example, the image acquisition unit 102 acquires images from digital versatile disc (DVD), blu-ray disc (BD), secure digital (SD) cards, or the like.

In other words, the stereoscopic image output device 100 is applicable to Blu-Ray recorders and the like.

The safety determination unit 103 determines whether a stereoscopic image acquired by the image acquisition unit 102 is a safe image. Specifically, the safety determination unit 103 compares a safe range of disparity and a normal distribution curve of disparities between corresponding points in the left-eye image and the right-eye image to determine whether the stereoscopic image is a safe image. In the present embodiment, it is determined whether a stereoscopic image is a safe image, based on the area of a region enclosed by the safe range of disparity and the normal distribution curve of disparities. The safe range of disparity in the present embodiment is a range of disparity set by a biomedical safety guideline.

The above safe range of disparity is quantification of the biomedical safety guideline defined by Japan Electronics and Information Technology Industries Association. Specifically, the safe range of disparity indicates a range of disparity that is recognized biomedically safe, and is quantification according to the resolution, the number of inches, and a viewing distance of the display unit 106 to a user.

When the safety determination unit 103 determines that the stereoscopic image is not a safe image, the notification unit 104 notifies the viewer that the stereoscopic image is not a safe image. In the present embodiment, the notification unit 104 displays on the display unit 106 a message (image) indicating that the stereoscopic image is not a safe image.

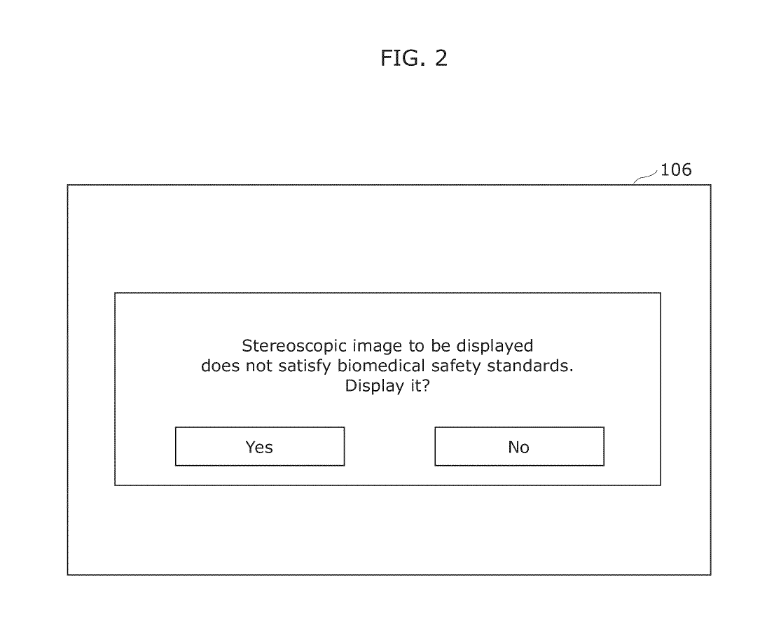

FIG. 2 shows an example display of such a message indicating that a stereoscopic image is not a safe image.

As shown in FIG. 2, in the present embodiment, the notification unit 104 displays, on the display unit 106, messages indicating that the stereoscopic image is not a safe image and asking the viewer for instructions as to whether to permit to display the stereoscopic image. This allows the viewer to select whether to display the stereoscopic image by inputting the instructions via the input unit 107 described below.

It should be noted that the notification from the notification unit 104 that the stereoscopic image is not a safe image is not limited thereto. For example, the notification unit 104 may so notify the user by outputting a sound via a speaker not shown, indicating that the stereoscopic image is not a safe image.

The display unit 106 displays the left-eye image and the right-eye image. The display unit 106 according to the present embodiment is a display which displays a stereoscopic image by alternately displaying the left-eye image and the right-eye image in a fixed cycle. Examples of the display unit 106 include a liquid crystal display, a plasma display, and an organic electro luminescence (EL) display.

In the present embodiment, the viewer views the display, wearing eyeglasses for stereoscopic image viewing. The eyeglasses for stereoscopic image viewing open and close liquid crystal shutters of left and right lens, in synchronization with a time at which the display unit 106 displays the left-eye image and the right-eye image, thereby allowing the viewer to view a stereoscopic image. In this case, the display unit 106 alternately outputs the left-eye image and the right-eye image, according to the display timing, and, at the same time, outputs, to the eyeglasses for stereoscopic image viewing, instructions to open and close the liquid crystal shutters in accordance with the time at which the left-eye image and the right-eye image are outputted.

The display unit 106 may be, for example, a display device which can perform stereoscopic display, without requiring the eyeglasses for stereoscopic image viewing, such as a liquid crystal display which has a lenticular lens on a display surface.

It should be noted that the display unit 106 is not necessary. An output unit which outputs a stereoscopic image may be provided instead of the display unit 106, and the output unit may output a stereoscopic image to a display device which is different from the stereoscopic image output device 100.

The input unit 107 is a user interface which receives input of various instructions (requests) from a viewer. The input unit 107 according to the present embodiment is a remote controller. It should be noted that the input unit 107 may be a graphic user interface (GUI) or the like which accepts operation of a touch panel overlaid on a display screen of the display unit 106.

Next, the overall operation of the stereoscopic image output device 100 will be described.

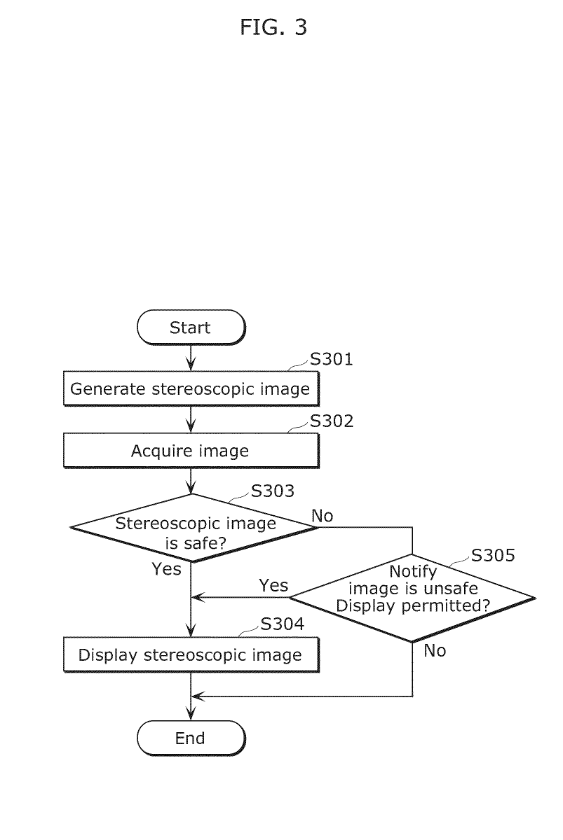

FIG. 3 is a flowchart illustrating the overall operation of the stereoscopic image output device 100 according to the embodiment of the present invention.

First, the stereoscopic image generation unit 101 generates a stereoscopic image (S301). Details of a method for generating a stereoscopic image according to the present embodiment will be described below.

Next, the image acquisition unit 102 acquires the left-eye image and the right-eye image generated by the stereoscopic image generation unit 101.

Next, the safety determination unit 103 determines whether the stereoscopic image (the left-eye image and the right-eye image) acquired by the image acquisition unit is safe for a viewer (S303). Specifically, first, the safety determination unit 103 calculates, for pairs of corresponding points, disparities between a plurality of points in one of the left-eye image and the right-eye image and a corresponding plurality of points in the other. In the present embodiment, in particular, the safety determination unit 103 calculates a disparity for each pair of feature points for specifying a shape of a subject included in the stereoscopic image.

Next, the safety determination unit 103 determines whether the stereoscopic image is a safe image by comparing a normal distribution curve, in which the distribution of the calculated plurality of disparities is approximated, and the safe range of disparity which indicates a range of disparity in which the stereoscopic image is recognized as a safe image for the viewer. Detail of a method for determining the safety of an image by the safety determination unit 103 will be described.

When the safety determination unit 103 determines that the stereoscopic image is a safe image (Yes in S303), the display unit 106 alternately displays the left-eye image and the right-eye image on the display screen (S304).

When the safety determination unit 103 determines that the stereoscopic image is not a safe image (No in S303), first, the notification unit 104 displays a message indicating that the stereoscopic image is unsafe as shown in FIG. 2, and asks the viewer for instructions whether to permit display of the stereoscopic image (S305).

The viewer inputs, through the input unit 107, instructions to permit or forbid the display of an unsafe image notified by the notification unit 104.

When the viewer permits the display of the stereoscopic image, specifically, when the viewer selects “Yes” using a remote controller (Yes in S305) in a state where the message of FIG. 2 is being displayed, the display unit 106 displays the stereoscopic image (S304).

On the other hand, when the viewer permits the display of the stereoscopic image, that is, when the viewer selects “No” to the message shown in FIG. 2 (No in 305), the display unit 106 ends the processing, without displaying the stereoscopic image.

It should be noted that the notification unit 104 may not ask the viewer for the instructions whether to permit the display of the stereoscopic image. In such a case, when the safety determination unit 103 determines that the stereoscopic image is not a safe image, the display unit 106 does not display the stereoscopic image. In other words, the display unit 106 alternately displays the left-eye image and the right-eye image only when the safety determination unit 103 determines that the stereoscopic image is a safe image.

Next, details of the method for generating a stereoscopic image by the stereoscopic image generation unit 101 will be described.

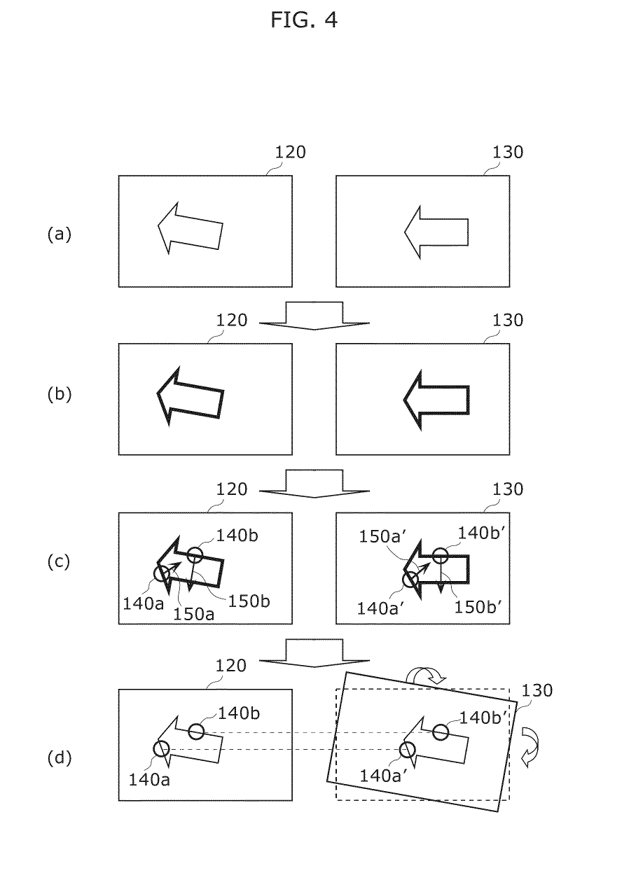

FIG. 4 is a diagram illustrating the method for generating a stereoscopic image by the stereoscopic image generation unit 101.

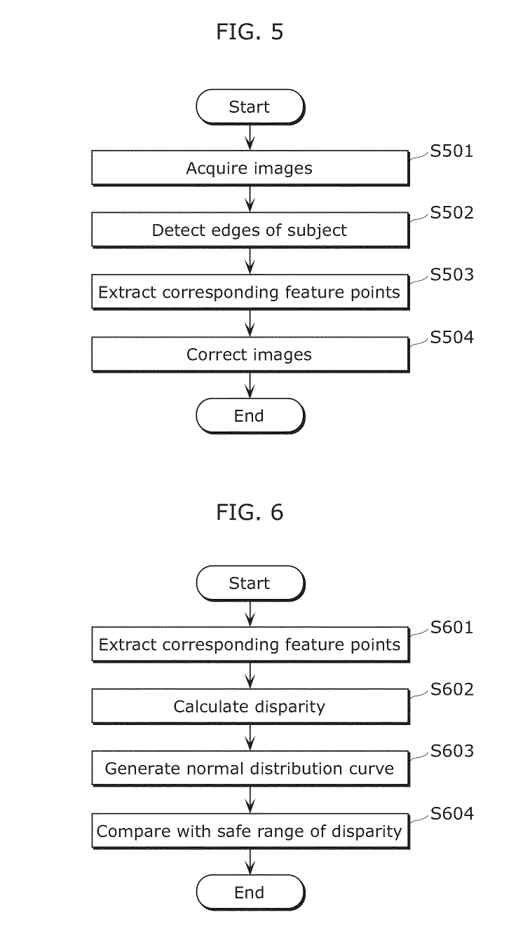

FIG. 5 is a flowchart illustrating generation of a stereoscopic image by the stereoscopic image generation unit 101. FIG. 5 is a flowchart illustrating details of step S301 of the flowchart of FIG. 3.

First, as shown in (a) of FIG. 4, the stereoscopic image generation unit 101 acquires an image (S501 of FIG. 5). The stereoscopic image generation unit 101 according to the present embodiment acquires two images, a first image 120 and a second image 130, by way of example. The first image 120 and the second image 130 are images obtained by taking images of the same subject from different viewpoints in the horizontal direction, and the images have a disparity therebetween in the horizontal direction of the images. Also, unintended shit is present in the different viewpoints in the vertical direction, due to a tilt of an imaging device used for taking the images of the subject. In other words, the first image 120 and the second image 130 have a disparity therebetween in the vertical direction of the images as well. For generation of a stereoscopic image by using the first image 120 and the second image 130, the disparity between the images in the vertical direction is not necessary. Thus, a process is performed as below in which the disparity between the first image 120 and the second image 130 in the vertical direction is cancelled while keeping the disparity in the horizontal direction.

First, as shown in (b) of FIG. 4, the stereoscopic image generation unit 101 detects edges which are outlines of the subject in the first image 120 and the second image 130 (S502 of FIG. 5). For example, a Laplacian filter is used to detect the edges of the subject. The Laplacian filter is a filter which extracts, for each pixel of an image, a portion in which an amount of change in brightness is extreme. In other words, one of corresponding portions in the first image 120 and the second image 130, in which changes in brightness is greater than the other is detected as the edge. It should be noted that a portion in which changes in hue is greater than the other may be detected as the edge.

Next, as shown in (c) of FIG. 4, the stereoscopic image generation unit 101 extracts a plurality of feature points in the first image 120 and a plurality of feature points in the second image 130 (S503 of FIG. 5).

Specifically, first, the stereoscopic image generation unit 101 detects a plurality of feature points on the edges of the subject in the first image 120 and the second image 130.

In the example shown in (c) of FIG. 4, the stereoscopic image generation unit 101 extracts feature points 140a and 140b in the first image 120, and extracts feature points 140a′ and 140b′ in the second image 130. The number of feature points actually extracted is determined in view of balance between load of the processing for extracting feature points and accuracy of an image to be generated.

Subsequently, the stereoscopic image generation unit 101 calculates the brightness vector of each feature point. The brightness vector is a vector indicating a direction in which the brightness changes and a magnitude of changes in the brightness. The brightness vector is obtained from a difference of the brightness of a pixel at a feature point from the brightness of pixels around the feature point.

In the example shown in (c) of FIG. 4, the stereoscopic image generation unit 101 calculates a brightness vector 150a at the feature point 140a and a brightness vector 150b at the feature point 140b in the first image 120. Likewise, the stereoscopic image generation unit 101 calculates a brightness vector 150a′ at the feature point 140a′ and a brightness vector 150b′ at the feature point 140b′ in the second image 130.

Subsequently, the stereoscopic image generation unit 101 associates feature points included in the first image 120 and feature points included in the second image 130. Specifically, the brightness vector at each feature point included in the first image 120 and the brightness vector at each feature point included in the second image 130 are compared to obtain correlation between the brightness vectors at all the feature points included in the first image 120 and the second image 130. Based on the obtained correlation between the brightness vectors at all the feature points, feature points having a similar brightness vector are associated with each other.

In the example shown in (c) of FIG. 4, the brightness vector 150a and the brightness vector 150a′ are in close correlation. Thus, the stereoscopic image generation unit 101 associates the feature point 140a and the feature point 140a′. Likewise, the brightness vector 150b and the brightness vector 150b′ are in close correlation. Thus, the stereoscopic image generation unit 101 associates the feature point 140b and the feature point 140b′.

Next, as shown in (d) of FIG. 4, the stereoscopic image generation unit 101 rotates or moves the second image 130 so that the disparities, in the vertical direction, between corresponding feature points in the first image 120 and the second image 130 are minimized, to generate a third image (S504 of FIG. 5).

The third image is, specifically, as shown in (d) of FIG. 4, obtained by correcting (rotating or moving) the second image so that locations of the corresponding feature points in the vertical direction of the image are the same. This can generate the first image and the third image in which the disparity therebetween remains only in the horizontal direction.

Last, the stereoscopic image generation unit 101 outputs one of the first image 120 and the third image as the left-eye image to the image acquisition unit 102, and outputs the other as the right-eye image to the image acquisition unit 102. Whether the first image 120 or the third image is to be used as the left-eye image is determined based on the orientation of the display between the first image 120 and the third image in the horizontal direction.

In the example shown in (d) of FIG. 4, when the subject is displayed projecting from the display screen of the display unit 106 toward the viewer, the first image 120 is an image from a viewpoint located to the right of the third image. Thus, the stereoscopic image generation unit 101 outputs the first image 120 as the right-eye image and outputs the third image as the left-eye image.

In contrast, when the subject is displayed receding into the display screen of the display unit 106 from the viewer, the stereoscopic image generation unit 101 outputs the first image 120 as the left-eye image and outputs the third image as the right-eye image.

It should be noted that due to the correction on the second image 130, a region may occur in which no image data is present in the periphery of the third image. In such a case, the peripheries of the first image 120 and the third image may be trimmed to remove the regions in which no image data is present in the peripheries. Alternatively, image data of the region in which no image data of the third image is present may be interpolated using color heuristic included in the image, image data of the first image 120 or the like.

Since the association of feature points in step S503 is based on the correlation in brightness vector, feature points that are essentially not corresponding to each other may be associated due to a fact that the brightness vectors thereof are similar by chance. Thus, in fact, the stereoscopic image generation unit 101 corrects the images so that the corresponding feature points are located in a range formed of a predetermined number of pixels in the vertical direction of the images. This allows the stereoscopic image generation unit 101 to reduce the disparity in the vertical direction of the images.

The details of the method for generating a stereoscopic image by the stereoscopic image generation unit 101 have been described above. However, the method for generating a stereoscopic image is not limited to the above method.

For example, depth information indicating the depths of a subject in acquired two images may be obtained and an image may be generated which has a disparity with one of the acquired images in the horizontal direction.

Alternatively, it is feasible to generate the left-eye image and the right-eye image even if the stereoscopic image generation unit 101 acquires one image. In such a case, for example, the stereoscopic image generation unit 101 may generate an image which has a disparity with one of the acquired images in the horizontal direction, using color heuristic included in the image or the like.

Next, details of a method for determining the safety of the stereoscopic image by the safety determination unit 103 will be described.

FIG. 6 is a flowchart illustrating a safety determination process of the safety determination unit 103. FIG. 6 is a flowchart further illustrating step S303 of the flowchart shown in FIG. 3.

First, the safety determination unit 103 extracts corresponding feature points in a left-eye video and a right-eye video which are acquired by the image acquisition unit 102 (S601 of FIG. 6). In the present embodiment, the data of the corresponding feature points calculated by the method described with reference to FIG. 4 and FIG. 5 by the stereoscopic image generation unit 101 may be stored and used as it is.

If the stereoscopic image output device 100 does not include the stereoscopic image generation unit 101, the safety determination unit 103 extracts corresponding feature points in the left-eye video and the right-eye video by a method corresponding to steps S502 and S503 of FIG. 5.

Next, the safety determination unit 103 calculates a disparity for each of a pair of corresponding feature points (S602 of FIG. 6). In the present embodiment, the disparity between the pair of the corresponding feature points is represented by the number of pixels on the display screen. Also in the present embodiment, the disparity is represented in amount having a sign. Specifically, when the subject is displayed receding into the display screen from the viewer, the disparity is represented in an amount having minus sign. In contrast, when the subject is displayed projecting from the display screen toward the viewer, the disparity is represented in an amount having plus sign.

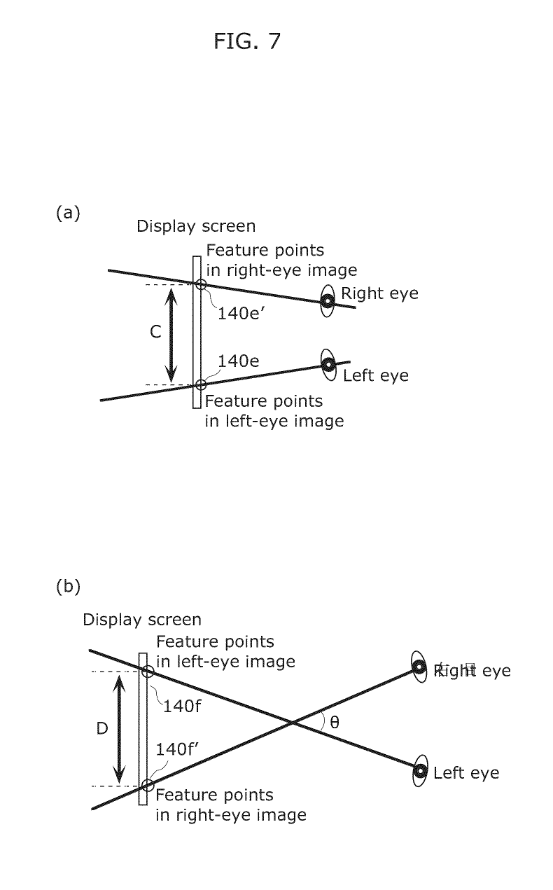

FIG. 7 is a diagram illustrating signs of disparity.

Part (a) of FIG. 7 is a top view where the subject is displayed receding into the display screen of the display unit 106 from the viewer. As shown in (a) of FIG. 7, a feature point 140e in the left-eye image is located to the left of a corresponding feature point 140e′ in the right-eye image in the horizontal direction of the images. In such a case, the disparity of the stereoscopic image calculated by the safety determination unit 103 is the disparity that has minus sign.

Part (b) of FIG. 7 is a top view illustrating a disparity where the subject is displayed projecting from the display screen of the display unit 106 toward the viewer. As shown in (b) of FIG. 7, a feature point 140f in the left-eye image is located to the right of a corresponding feature point 140f′ in the right-eye image in the horizontal direction of the images. In such a case, the disparity of the stereoscopic image calculated by the safety determination unit 103 is the disparity that has plus sign.

It should be noted that the disparity calculated as the amount having a sign as described above may include a disparity greater or smaller than an actual disparity. This is because there may be an error at association of the feature points in, for example, an image in which a plurality of objects having a similar shape are present, or an image which includes a large number of regions having uniform brightness, since the feature points are associated with each other based on the correlation (similarity) in the brightness vector at the feature points.

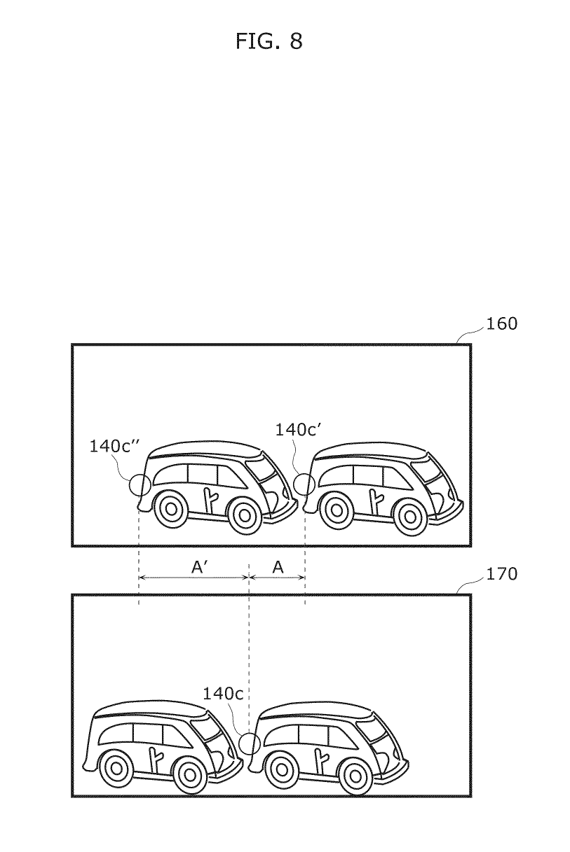

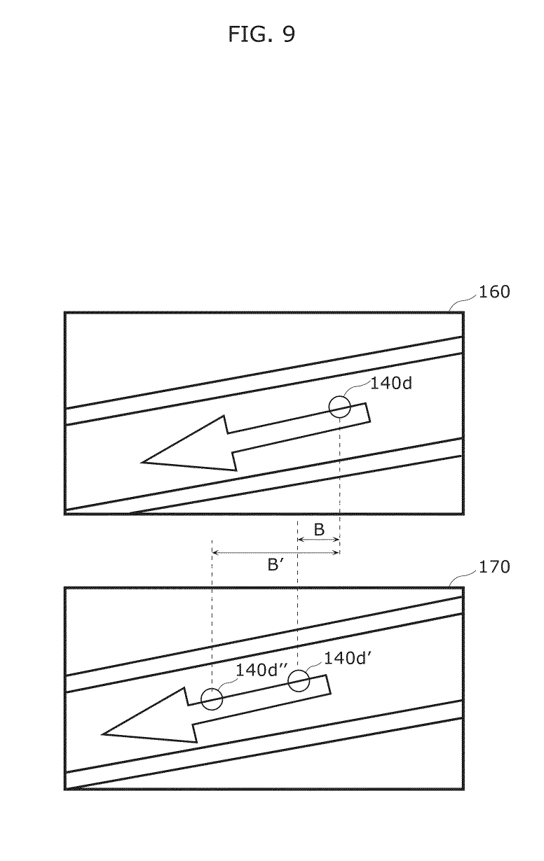

FIG. 8 and FIG. 9 are diagrams each showing an example where incorrect feature points are associated with each other.

FIG. 8 shows an example where images of two vehicles having a same model in line are taken in a left-eye image 160 and a right-eye image 170.

In FIG. 8, a feature point 140c′ in the left-eye image 160 corresponds to a feature point 140c in the right-eye image 170. The feature point 140c′ and the feature point 140c are points on left edges of a vehicle located on the right side of the images. In the case of FIG. 8, however, the brightness vector at a point on the left edge of the vehicle located to the right side of the right-eye image 170 may resemble the brightness vector at a point on the left edge of the vehicle located to the left side of the left-eye image 160. In other words, the feature point 140c in the right-eye image 170 may incorrectly be associated with the feature point 140c″ in the left-eye image 160.

In this case, in the example of FIG. 8, despite a correct amount of disparity at the feature point 140c in the right-eye image 170 is a disparity A, an incorrect disparity A′ is calculated.

FIG. 9 shows an example where there are a large number of regions which have uniform brightness in the left-eye image 160 and the right-eye image 170. Arrow shapes shown in the left-eye image 160 and the right-eye image 170 of FIG. 9 each have a uniform brightness (color), and the brightness around the arrow shape is also uniform. Thus, many brightness vectors at points on the edge of the arrow shape are similar. Thus, it is likely that incorrect feature points are associated with each other.

For example, a feature point 140d′ in the right-eye image 170 corresponds to a feature point 140d in the left-eye image 160 in FIG. 9. However, the feature point 140d may incorrectly be associated with the feature point 140d″ the brightness vector at which resembles that of the feature point 140d′ in the left-eye image 160.

In this case, in the example of FIG. 9, despite a correct disparity at the feature point 140d in the left-eye image 160 is a disparity B, an incorrect disparity B′ is calculated.

While FIG. 8 and FIG. 9 show the cases where the disparity is incorrectly calculated a large value, there is, of course, a case where the disparity is incorrectly calculated a small value.

As described above, for association of feature points using brightness vectors, the disparity is incorrectly calculated in many cases, and it is very difficult to prevent this altogether.

Thus, in a method where it is simply determined that a stereoscopic image is unsafe because the number of pairs of feature points the disparities of which exceed the safe range of disparity is greater than or equal to a predetermined threshold, a stereoscopic image which is in fact safe may be determined to be an unsafe stereoscopic image because of the disparities between incorrectly associated feature points.

Thus, the present invention compares the normal distribution curve of disparities and the safe range of disparity, rather than counting the number of disparities off the safe range of disparity, to correctly determine the safety of the stereoscopic image.

First, the safety determination unit 103 obtains an average and variance of disparities calculated for pairs of corresponding feature points to generate a normal distribution curve of disparities represented by a probability density function (S603 of FIG. 6). The probability density function for a disparity x is obtained by the following mathematical equation where p represents the average of disparities, and a represents standard deviation.

$$\begin{matrix}[ Eq . 1 ] & \\ f ( x ) = \frac{1}{\sqrt{2 π {σ}^{2}}} exp \{ - \frac{{( x - μ )}^{2}}{2 {σ}^{2}} \} & ( Eq . 1 )\end{matrix}$$

Next, the safety determination unit 103 compares the generated normal distribution curve and the safe range of disparity to determine whether the stereoscopic image is a safe image (S604 of FIG. 6).

First, the safe range of disparity will be described. In the present embodiment, the safe range of disparity is determined by an upper limit and a lower limit of the disparity which are defined by the biomedical safety guideline, and is represented by the number of pixels.

The range of the disparity defined by the biomedical safety guideline will be described again with reference to FIG. 7.

As shown in (a) of FIG. 7, when the subject is displayed receding into the display screen from the viewer, the limit of the safe range of disparity defined by the biomedical safety guideline is defined within 5 cm on the display screen, on which the stereoscopic image is displayed, in the horizontal direction. An amount of the disparity in this case has minus sign.

Thus, the lower limit of the safe range of disparity is an amount which represents a disparity C corresponding to 5 cm on the display screen in the horizontal direction by the number of pixels having minus sign added thereto. The lower limit of the safe range of disparity is, specifically, obtained based on the size of the display screen and the resolution of the display screen.

On the other hand, when subject is displayed projecting from the display screen toward the viewer as shown in (b) of FIG. 7, the limit of the safe range of disparity defined by the biomedical safety guideline is obtained by an angle of convergence represented by an angle θ shown in (b) of FIG. 7. Specifically, the limit of the safe disparity is a disparity on the display screen where the angle of convergence is within 1 degree. The disparity in this case is an amount which has plus sign as described above.

Thus, in the present embodiment, the upper limit of the safe range of disparity is an amount representing a disparity D corresponding to the angle of convergence within 1 degree on the display screen by the number of pixels and adding the plus sign to the disparity D. The upper limit of the safe range of disparity is, specifically, obtained based on the size of the display screen, the resolution of the display screen, and a viewing position of the viewer.

It should be noted that the safe range of disparity is not limited to be defined by the biomedical safety guideline.

For example, the safe range of disparity may be set to a range disparity narrower than the range of disparity defined by the biomedical safety guideline.

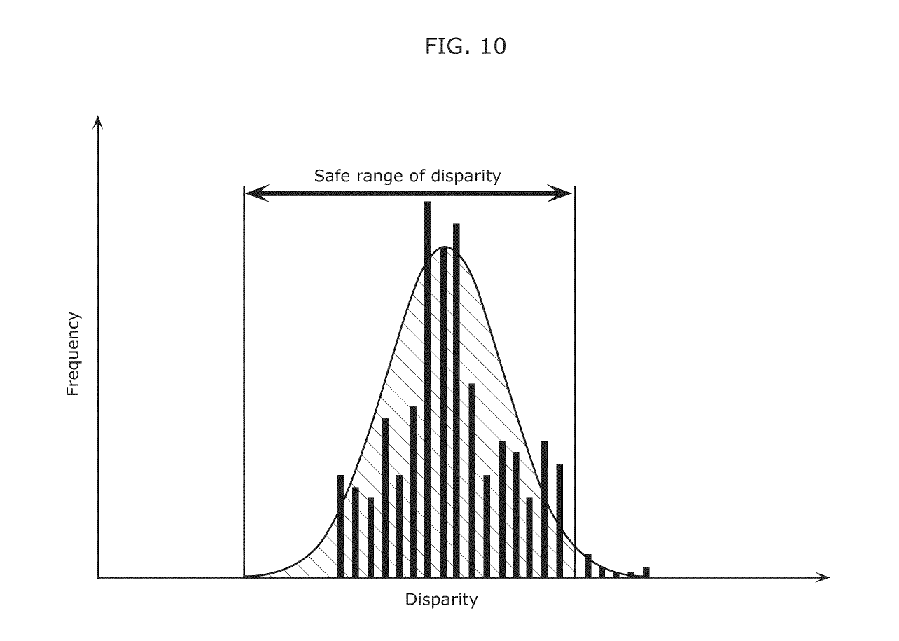

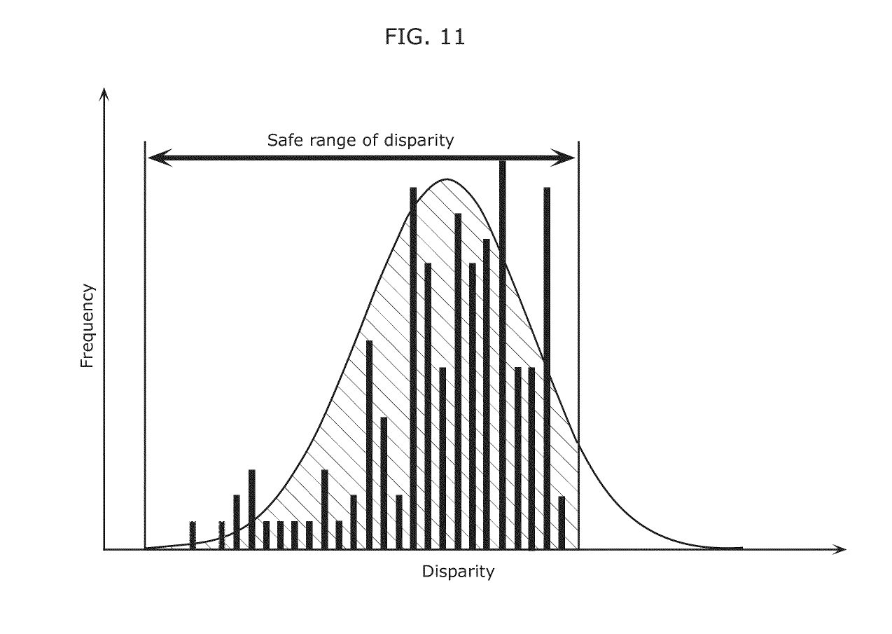

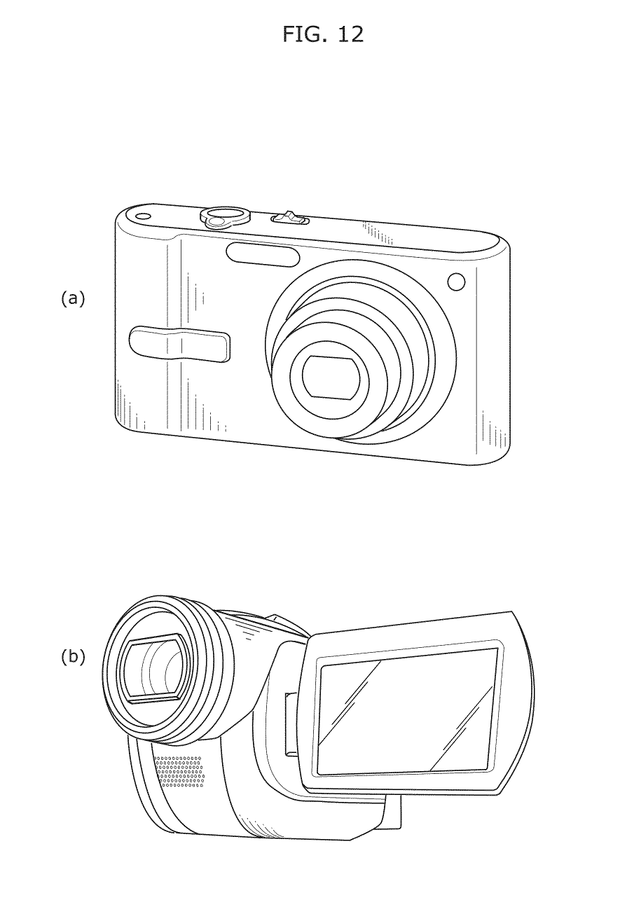

FIG. 10 and FIG. 11 are diagrams each illustrating safety determination by the safety determination unit 103.

In FIG. 10 and FIG. 11, the normal distribution curve obtained from the disparities, a histogram indicating an actual distribution of the disparities, and the safe range of disparity defined by the biomedical safety guideline are shown. The disparity (the number of pixels) is indicated on the horizontal axes in FIG. 10 and FIG. 11, the number of feature points (frequency) is indicated on the vertical axis. The left end of the safe range of disparity represents the lower limit described above, and the right end of the safe range of disparity represents the upper limit.

FIG. 10 is a diagram showing an example distribution of the disparities determined to be safe by the safety determination unit 103.

In the present embodiment, the safety determination unit 103 determines that the stereoscopic image is a safe image when a percentage of the area of a region included in the safe range of disparity over the area of the region enclosed by the normal distribution curve is greater than a predetermined threshold (for example, 90% or above).

The region included in the safe range of disparity in the region enclosed by the normal distribution curve is a region indicated by hatched lines in FIG. 10. The safety determination unit 103 determines that the stereoscopic image is a safe image when the percentage of the area of the region included in the safe range of disparity over the area of the region enclosed by the normal distribution curve is greater than or equal to a predetermined percentage.

In FIG. 10, comparing the histogram and the safe range of disparity, while there are pairs of feature points which have the disparity therebetween off the safe range of disparity, the area of the region included in the safe range of disparity in the area of the region enclosed by the normal distribution curve is greater than or equal to a predetermined percentage. Thus, the stereoscopic image which has such distribution of disparities is determined to be safe.

On the other hand, FIG. 11 is a diagram showing an example distribution of the disparities determined to be unsafe by the safety determination unit 103.

In FIG. 10, comparing the histogram and the safe range of disparity, there is no pair of feature points that have the disparity therebetween off the safe range of disparity. The stereoscopic image having a distribution of disparities as shown in FIG. 11, however, has large variations in disparity, and a percentage of the area of the region, indicated by hatched lines in FIG. 11, included in the safe range of disparity over the area of the region enclosed by the normal distribution curve is less than the predetermined percentage. Thus, the stereoscopic image which has such distribution of disparities is determined to be unsafe.

Typically, the disparities of the stereoscopic image vary to some extent. However, if the disparities vary to a large extent as in FIG. 11, which may cause adversely effect to the viewer such as image-induced sickness. Also, in the example of FIG. 11, while there is no disparity off the safe range of disparity, if the disparities vary to a large extent, a pair of feature points incorrectly associated with each other as described above may, by chance, have a disparity within the safe range of disparity.

Thus, it is reasonable that the safety determination unit 103 determines the stereoscopic image, in which the disparities vary to a large extent, as an unsafe stereoscopic image.

In this manner, the safety determination unit 103 determines the safety of the stereoscopic image by the normal distribution curve of disparities, thereby accurately determining the safety of the stereoscopic image.

It should be noted that the method for determining the safety by comparison of the normal distribution curve and the safe range of disparity is not limited to the above. For example, the safety determination unit 103 may determine that a stereoscopic image is a safe image when an entire region determined by the normal distribution curve of disparities in the stereoscopic image, the axis of the normal distribution curve, and a segment represented by μ±n×σ is included in the safe range of disparity, where p represents the average of the disparities in the stereoscopic image, σ represents the standard deviation, and n is a positive number (or a natural number).

While the stereoscopic image output device according to the present invention has been described above with reference to the embodiment, the present invention is also applicable to a stereoscopic video formed of a plurality of stereoscopic images.

Specifically, the image acquisition unit 102 acquires a plurality of left-eye images and a plurality of right-eye images which form a stereoscopic video in playback order of the stereoscopic video. The stereoscopic image output device may serve as a stereoscopic video output device by performing the process described with reference to the embodiment on each of the left-eye images and the right-eye images included in the stereoscopic video.

In the stereoscopic image output device serving as the stereoscopic video output device, the notification unit 104 notifies a viewer that the stereoscopic video is not a safe video in a period where the stereoscopic image determined to be unsafe by the safety determination unit 103 is included.

Here, the notification unit 104 included in the stereoscopic image output device serving as the stereoscopic video output device may notify that the stereoscopic video is not a safe video once stereoscopic images determined to be unsafe by the safety determination unit 103 continue for a fixed time period.

Alternatively, the output unit included in the stereoscopic image output device serving as the stereoscopic video output device may stop output of the stereoscopic video in a period in which the stereoscopic images determined to be unsafe by the safety determination unit 103 are included.

It should be noted that while the present invention has been described with reference to the above embodiment, the present invention is, of course, not limited to the above embodiment. The present invention includes the following variations.

(1) The devices described above can be implemented in, specifically, a computer system which includes a microprocessor, a ROM, a RAM, a hard disk unit, a display unit, a keyboard, a mouse, and the like. A computer program is stored in the RAM or the hard disc unit. By the microprocessor operating in accordance with the computer program, each device achieves its function. Here, the computer program is, to achieve predetermined functionality, configured in combination with a plurality of instruction code indicating instructions to the computer.

(2) Part or the whole of the components included in each of the devices described above may be configured with one system LSI (Large Scale Integration). The system LSI is a super multi-function LSI manufactured by integrating a plurality of components on one chip, and is, specifically, a computer system which includes a microprocessor, a ROM, a RAM, and the like. A computer program is stored in the ROM. The system LSI achieves its function by the microprocessor loading the computer program from the ROM into the RAM and performing operations such as computing in accordance with the loaded computer program.

(3) Part or the whole of the components included in each of the devices described above may be configured with an IC card or a single module removably attached to each device. The IC card or the module is a computer system which includes a microprocessor, a ROM, a RAM, and the like. The IC card or the module may include the super multi-function LSI described above. The IC card or the module achieves its function by the microprocessor operating in accordance with the computer program. The IC card or the module may be of tamper-resistant.

(4) The present invention may be implemented in the methods described above. Moreover, the present invention may be achieved in a computer program implementing the methods by a computer, or may be achieved in digital signals which include the computer program.

Alternatively, the present invention may be implemented in a computer-readable recording medium having stored therein a computer program or digital signals, for example, a flexible disk, a hard disk, CD-ROM, MO, DVD, DVD-ROM, DVD-RAM, BD (Blu-ray Disc), or a semiconductor memory. Alternatively, the present invention may be implemented in the digital signal stored in these recording media.

The present invention may transmit the computer program or the digital signals via an electric communication line, a wireless or wired communication line, a network represented by the Internet, data broadcast, or the like.

Moreover, the present invention may be implemented in a computer system which includes a microprocessor and a memory, the memory may store therein the computer program, and the microprocessor may operate in accordance with the computer program.

Moreover, by transferring the program or the digital signals stored in the recording medium, or transferring the program or the digital signals via the network or the like, the program or the digital signals may be executed in other independent computer system.

(5) The above-described embodiment and variations may be combined.

The embodiment and the variations of the stereoscopic image output device according to one aspect of the present invention have been described.

The stereoscopic image output device according to the embodiment can accurately determine the safety of the stereoscopic image and the stereoscopic video when displaying the stereoscopic image and the stereoscopic video, and notify the user of the determination result.

This notifies the viewer that a stereoscopic image and a stereoscopic video are unsafe when the stereoscopic image and the stereoscopic video have great disparities. Thus, the adversely effect to the viewer's health can be prevented.

Moreover, the stereoscopic image output device according to each embodiment described above is implemented in, for example, a DSC shown in (a) of FIG. 12 or a digital video camera shown in (b) of FIG. 12.

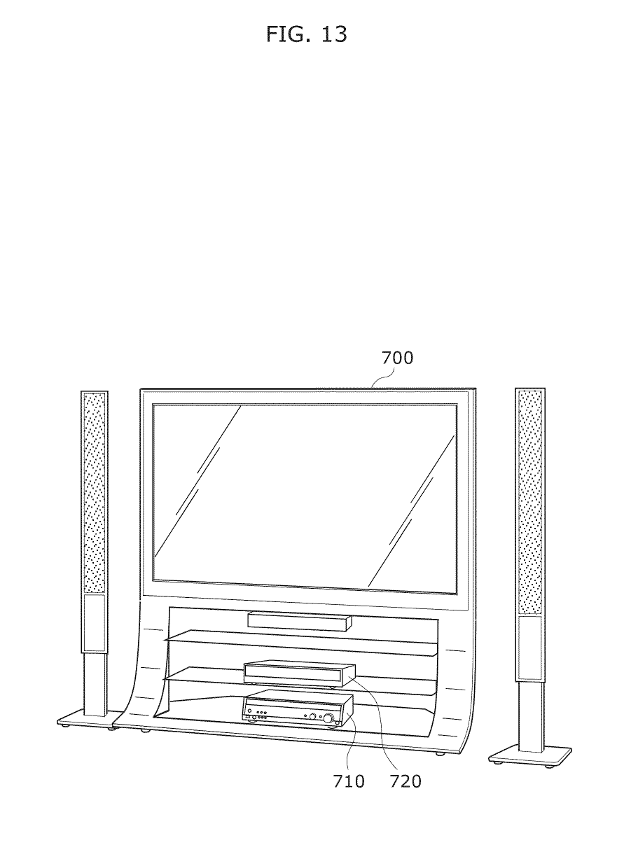

Moreover, for example, the stereoscopic image output device according to the above embodiment is implemented in a TV 700 shown in FIG. 13. Here, specific configuration of the display unit 106 is, although not particularly limited to, a liquid crystal display, a plasma display, or an organic EL display which can perform stereoscopic display, for example. In this case, the image acquisition unit 102 acquires images from television broadcasting, a Blu-Ray player 710 and a set top box 720 shown in FIG. 13.

Moreover, the stereoscopic image output device may be implemented in the Blu-Ray player 710. In this case, the image acquisition unit 102 acquires images from a Blu-Ray disc inserted into the Blu-Ray player 710. The images may be acquired, not limited to from the Blu-Ray disc, from any recording medium such as a DVD and a hard disc drive (HDD).

Furthermore, the stereoscopic image output device may be implemented in the set top box 720. In this case, the image acquisition unit 102 acquires images from cable television broadcasting and the like.

The present invention can also be implemented in a stereoscopic image output method.

The present invention is not limited to the embodiment and the variations thereof. Various modifications to the present embodiment or the variations thereof that may be conceived by those skilled in the art or other embodiments constructed by combining constituent elements in different embodiment or the variations thereof are included in the scope of the present disclosure, without departing from the essence of the present disclosure.

### INDUSTRIAL APPLICABILITY

According to the present invention, the safety of the stereoscopic image and the stereoscopic video can be accurately determined by obtaining the normal distribution curve of disparities in the stereoscopic image. Thus, the present invention is useful as a stereoscopic image output device for use in digital TVs and digital cameras.

### REFERENCE SIGNS LIST

100 Stereoscopic image output device
101 Stereoscopic image generation unit
102 Image acquisition unit
103 Safety determination unit
104 Notification unit
106 Display unit
107 Input unit
120 First image
130 Second image
140a, 140b, 140c, 140d, 140e, 140f Feature point
140a′, 140b′, 140c′, 140d′, 140e′, 140f′ Feature point
140c″, 140d″ Feature point
150a, 150b, 150a′, 150b′ Brightness vector
160 Left-eye image
170 Right-eye image
700 TV
710 Blu-ray player
720 Set top box

1. A stereoscopic image output device comprising:
an image acquisition unit configured to acquire a left-eye image and a right-eye image which form a stereoscopic image;
an output unit configured to output the left-eye image and the right-eye image acquired by the image acquisition unit;
a safety determination unit configured to determine whether the stereoscopic image is a safe image by comparing a normal distribution curve obtained from disparities between corresponding points in the left-eye image and the right-eye image and a safe range of disparity indicating a range of disparity in which the stereoscopic image is recognized as a safe image for a viewer; and
a notification unit configured to notify the viewer that the stereoscopic image is not a safe image when the safety determination unit determines that the stereoscopic image is not a safe image.

2. The stereoscopic image output device according to claim 1,
wherein the safety determination unit is configured to extract, from the left-eye image and the right-eye image, a plurality of feature points for specifying a shape of a subject included in the stereoscopic image, calculate disparities between the feature points corresponding to each other in the left-eye image and the right-eye image, and approximate a frequency distribution of the calculated disparities, to calculate the normal distribution curve.

3. The stereoscopic image output device according to claim 1,
wherein the safety determination unit is configured to determine that the stereoscopic image is a safe image when a percentage of an area of a region included in the safe range of disparity over an area of a region enclosed by the normal distribution curve is greater than or equal to a predetermined threshold.

4. The stereoscopic image output device according to claim 1,
wherein the output unit is a display unit configured to alternately display the left-eye image and the right-eye image, and
when the safety determination unit determines that the stereoscopic image is not a safe image, the notification unit is configured to show, on the display unit, that the stereoscopic image is not a safe image.

5. The stereoscopic image output device according to claim 4,
wherein the display unit is configured to alternately display the left-eye image and the right-eye image only when the safety determination unit determines that the stereoscopic image is a safe image.

6. The stereoscopic image output device according to claim 1, further comprising
a stereoscopic image generation unit configured to acquire a first image and a second image obtained by taking images of a subject from different positions, and rotate or move the second image so that disparities between corresponding points in the first image and the second image are minimized in a vertical direction of the first image and the second image, to generate a third image,
wherein the image acquisition unit is configured to acquire one of the first image and the third image as the left-eye image, and the other as the right-eye image.

7. The stereoscopic image output device according to claim 1,
wherein the image acquisition unit is configured to acquire a plurality of the left-eye images and a plurality of the right-eye images which form a stereoscopic video in a playback order of the stereoscopic video.

8. The stereoscopic image output device according to claim 1,
wherein the safe range of disparity is a range of disparity determined by a biomedical safety guideline.

9. A stereoscopic image output method comprising:
(a) acquiring a left-eye image and a right-eye image which form a stereoscopic image;
(b) outputting the left-eye image and the right-eye image acquired in step (a);
(c) determining whether the stereoscopic image is a safe image by comparing a normal distribution curve obtained from disparities between corresponding points in the left-eye image and the right-eye image and a safe range of disparity indicating a range of disparity in which the stereoscopic image is recognized as a safe image for a viewer; and
(d) notifying the viewer that the stereoscopic image is not a safe image when it is determined that the stereoscopic image is not a safe image.
